(19) United States
(12) Patent Application Publication
(10) Pub. No.: US 2011/0254422 A1
(43) Pub. Date: Oct. 20, 2011

(54) LED lamp circuit

(75) Inventors: William Wagner, New York, NY (US); Joel Slavis, New York, NY (US)

(73) Assignee: LED WAVES LLC, Brooklyn, NY (US)

(21) Appl. No.: 12/760,976

(22) Filed: Apr. 15, 2010

(51) Int. Cl. H01J 61/52; H01J 9/24

(52) U.S. Cl. 313/46; 445/23

(57) ABSTRACT

A method of making an LED lamp circuit achieves uniform heating and cooling of an LED lamp to extend its lifetime. Steps include: providing a circuit board for an LED lamp and dispersing a plurality of light emitting diodes across a surface of the circuit board; distributing an LED driver on a surface of the circuit board so that the light-emitting-diode driver is not a distinctly identifiable component, does not interfere with the light output of the LEDs, and enables the LED driver to uniformly heat the LEDs when powering the LEDs; configuring the LED driver to attach to a power input; and integrating a heat sink to a surface of the circuit board, the heat sink configured to uniformly remove heat from the LEDs and the LED driver. The invention includes an LED lamp circuit made according to the method.

### TECHNICAL FIELD

In the field of electric lamp and discharge devices, a combined load device and load device temperature modifying means and electrical circuit device structure uses plural circuit elements structurally combined with the load device structure.

### BACKGROUND ART

The prior art for LED (light emitting diode) lamps and drivers employs methods that combine separate components or modules and often utilize a plurality of heat sinks to cool the modules separately. An LED driver converts input electricity into electricity useful for LEDs.

The design of LED lamps heretofore has been aimed at diversity of power supply rather than to create a disposable LED lamp having a longevity justifying the additional expense of the LED lamp over a conventional fluorescent tube or incandescent bulb.

The latest modular designs exemplified by U.S. Pat. No. 6,787,999 (the '999 patent), employ modular components which allows a single LED-based optics module to connect with a plurality of different power sources. The '999 patent teaches away from the approach in the present invention because the electronics module is selectively adaptable to the light requirements, which is unattainable with the approach of the present invention to deliver a very long lasting but disposable LED lamp.

Maximal LED longevity in the present invention is achieved by creating uniformity of heat generation and thus temperature distribution affecting both the LEDs on the circuit board and the LED driver. Uniformity of heat generation is achieved by employing a single circuit board comprising dispersed heat generating components (the LEDs and the LED driver) and an integrated heat sink. A single circuit board according to the invention has a single heat sink electrical power input, LEDs and driver integrated in such a manner as to create an even temperature distribution on the LEDs in the circuit and the LED driver.

Some have suggested combining driver circuitry and LEDs on the same printed control board. But such combinations alone are inherently insufficient to meet the performance requirements of the present invention because they still involve isolated modules on the circuit board. For example, U.S. Patent Publication 2008/0122364 teaches a printed circuit board with LED array, driver and integrated heat sink. However, the devices' isolated arrangement on the printed circuit board results in uneven cooling of the lamp components. The use of an isolated LED module is inconsistent with the present invention as is any prior art teaching distinct electronics and lamp elements.

While modular LED components are often connected to a circuit board, no prior art found teaches the physical integration or attachment of the components to the same circuit board in a configuration that provides a uniform temperature distribution across the circuit board and its components to achieve maximal device performance and longevity.

Finally, distributing the complete driver circuitry on the same board as the LED modules has never been utilized in the industry because LED product designers have always been after modularity, instead of longevity and disposability. In the conventional approach, the LED arrays are produced in one module and the other components are produced in separate modules.

### SUMMARY OF INVENTION

A method of making an LED lamp circuit achieves uniform heating and cooling of an LED lamp to extend its lifetime. The method includes steps of providing a circuit board for an LED lamp and dispersing a plurality of light emitting diodes across a surface of the circuit board. Further steps include distributing an LED driver on the a surface of the circuit board in a configuration that the light-emitting-diode driver is not a distinctly identifiable component; does not interfere with the light output of the light emitting diodes; and, that enables the light-emitting-diode driver to uniformly heat the light emitting diodes when powering the light emitting diodes. Another step is configuring the LED driver to attach to a power input to supply power to the LEDs. Finally, it includes a step of integrating a heat sink to a surface of the circuit board, the heat sink configured to uniformly remove heat from the LEDs and the LED driver when the LEDs are powered by the LED driver. The invention includes an LED lamp circuit made according to the method.

### Technical Problem

LED Lamp modules and Driver modules are typically packaged separately. They are wired together even where the lamp is considered disposable (the driver module is not replaceable). However, this arrangement requires dedicating space that could otherwise be used for a heat sink to house the driver circuitry, and importantly leads to uneven heating of the LEDs, the LED driver and the circuit board. Uneven heating deleteriously affects longevity of the lamp. A shorter life is an economic consideration because it requires replacement upon failure. If the LED lamp life could be extended, this would positively impact consumer choice for LED lamps because replacement expenditures could be postponed over the longer life.

High temperatures cause LED lamps to dim and change color. Current LED arrays have uneven temperatures and consequently output a non-uniform brightness and color temperature. These variations in light output tend to detract from public acceptance of LED technology for general lighting purposes.

### Solution to Problem

The solution to the problem is an LED lamp circuit that enables uniform heating and cooling of the LEDs and the LED driver achieved by avoiding discrete modules and dispersing the LEDs and the LED driver together across the circuit board.

Any number of LED lamps may be dispersed within the driving circuitry so that thermal management may be integrated on the circuit board. Alternatively, the LED lamps can be placed on the opposing surface of the circuit board to thermally manage the lamp. The lamp circuit may be used with any variety of optics used with LED lamps. The illuminating elements and driving circuitry utilize the same thermal management system. The method of the invention builds a unified LED lamp which contains driving circuitry and illuminating elements on the same circuit board. The circuit board is then backed with a single heat sink, preferably a heat sink that has been designed for optimum thermal performance.

### Advantageous Effects of Invention

In addition to extending lifetime of the LED lamps, uniform thermal performance improves the light output characteristics of the LED lamp. These improved characteristics have the potential to enhance public acceptance of LED technology and encourage the use of LED lamps in substitution for incandescent and fluorescent bulbs.

The current invention provides a longer life to an LED lamp by controlling the addition and removal of heat to the LED lamp components. A longer LED lamp life could enhance environmental and economic choices in replacing existing fluorescent and incandescent bulbs.

The method also provides improved manufacturability of LED lamps by reducing the number of separate manufacturing operations required to build a lamp and by integrating supply chain sources.

### BRIEF DESCRIPTION OF DRAWINGS

The drawings illustrate preferred embodiments of LED lamp circuits derived from the method of the invention and the reference numbers in the drawings are used consistently throughout. New reference numbers in FIG. 2 are given the 200 series numbers. Similarly, new reference numbers in each succeeding drawing are given a corresponding series number beginning with the figure number.

FIG. 1 is a flow diagram illustrating the method of the invention.

FIG. 2 is a plan view of an LED lamp circuit that fits into a standard fluorescent tube.

FIG. 3 is sectional view of the device of FIG. 1, showing the heat sink, the circuit board, optics and LED lamps.

FIG. 4 is an alternative embodiment employing a circular array of LEDs fitting in a general purpose incandescent light bulb.

### DESCRIPTION OF EMBODIMENTS

In the following description, reference is made to the accompanying drawings, which form a part hereof and which illustrate several embodiments of the present invention. The drawings and the preferred embodiments of the invention are presented with the understanding that the present invention is susceptible of embodiments in many different forms and, therefore, other embodiments may be utilized and structural, and operational changes may be made, without departing from the scope of the present invention. For example, the steps in the method of the invention may be performed in any order that results in making or using the LED lamp circuit.

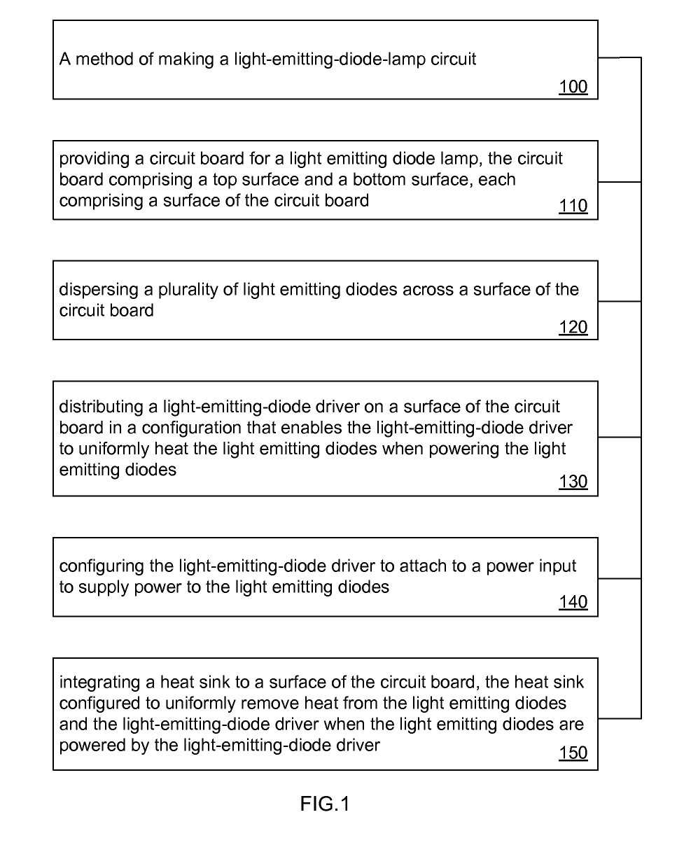

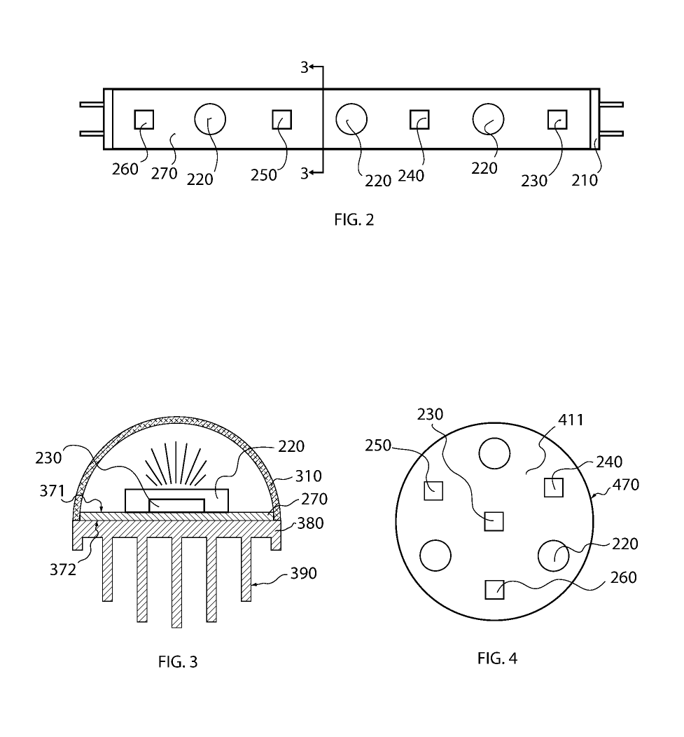

FIG. 1 illustrates the method of a preferred embodiment of the invention and FIGS. 2-4 illustrate embodiments showing the components referred to in the method.

A preferred embodiment of the invention is a method of making a light-emitting-diode-lamp circuit (100). The method includes a step (110) of providing a circuit board (270) for a light emitting diode lamp. The circuit board (270) comprises a top surface (371) and a bottom surface (372), each of which is referred to as a surface. Circuit boards, in general, are well known in the art. A circuit board (270) is essentially the mounting base for the components, so that the specific shape of the circuit board may vary depending on the application. The top surface (371) and the bottom surface (372) of a circuit board (270) are arbitrary designations in that either surface of the circuit board (270) may be so designated. Once chosen, this surface retains that designation for purposes of describing and understanding the invention.

The method further includes a step (120) of dispersing a plurality of light emitting diodes (220) across a surface of the circuit board (270), that is, across the top surface (371), across the bottom surface (372), or across both the top surface (371) and the bottom surface (372) of a circuit board (270). A uniform distribution across the top surface (371) of the circuit board (270) is preferred.

The configuration of dispersed light emitting diodes (220) is referred to as an LED array, which is first positioned to give the desired photometrics, or light distribution, in an isometric or Cartesian field, or other suitable arrangement, across either or both surfaces of the circuit board (270).

The method further includes a step (130) of distributing a light-emitting-diode driver on a surface of the circuit board in a configuration that enables the light-emitting-diode driver to uniformly heat the light emitting diodes when powering the light emitting diodes without interfering with the desired light output. The light-emitting-diode driver is not a single component, but rather a collection of components, including, for example, a bridge rectifier (260), controller integrated circuit (250), capacitors (240) and inductors (230). These light-emitting-diode driver components are installed on the same board amongst the light emitting diodes (220) to make up a driver circuit. The driver circuit converts electrical input into modulated direct-current electricity usable by the light emitting diodes (220).

The method further includes a step (140) of configuring the light-emitting-diode driver to attach to a power input to supply power to the light emitting diodes (220).

Thus, the space between the light emitting diodes (220) is filled by the driver components, such that the light output is not affected physically by shadows; each of the light emitting diodes (220) is roughly the same temperature during operation; and, the driver is connected (via circuit traces or other wiring) in such a way that the device (light emitting diode lamp) can be conveniently attached to an electrical input, and can safely power the light emitting diodes (220).

The method further includes a step (150) of integrating a heat sink (380) to a surface (372) of the circuit board (270), the heat sink (380) configured to uniformly remove heat from the light emitting diodes (220) and the light-emitting-diode driver when the light emitting diodes (220) are powered by the light-emitting-diode driver. For example, alternative embodiments of the invention may include driver circuitry dispersed on the bottom surface (372) of the circuit board, making more room on the top surface (371) for lamp elements. This dispersal meets the requirements of the invention because it must also accomplish the goal of uniform temperature of the light emitting diodes (220) during operation. In this case, the heat sink is formed with cavities for the driver components.

The invention encompasses the embodiment wherein the circuit board, also known as a base, may be made of the material comprising the heat sink, and thus, the circuit board in this embodiment would be indistinguishable from the heat sink.

The invention includes a light-emitting-diode-lamp circuit made according to the method disclosed.

### Example 1

FIG. 2 shows a preferred embodiment as an integrated light-emitting-diode-lamp circuit in a lamp that is built to the existing standards for fluorescent tube lights, i.e., that fits into a 1-inch diameter cylinder and that is powered by line voltage, alternating current electricity using bi-pin connectors at either end (210). This lamp can be used to retrofit existing fluorescent fixtures or as a new installation. The LED lighting elements (220) are installed onto a circuit board (270). Driver components such as a bridge rectifier (260), controller integrated circuit (250), capacitors (240) and inductors (230) are installed on the same circuit board (270) between the light emitting diodes to make up a driver circuit which converts line electricity into modulated direct current electricity usable by the light emitting diodes. Since both the driver and illumination elements are located on the same circuit board (270), they may be backed by a single extruded heat sink (380), which provides even temperature distribution by way of the heat sink fins (390). A lens housing (310) may then be mounted to provide the desired light spread and to secure the circuit board (270) to the heat sink (380).

### Example 2

In addition to linear lighting applications, the invention can be embodied in other formats, such as a circular array (411) as shown in FIG. 4. The LED driver components, which are signified by the inductors (230), capacitors (240), controller integrated circuit (250) and rectifier (260), are interspersed between the light emitting diodes (220). This circuit board (470) is then connectable to a standard light bulb adapter such as an Edison screw base, bi-pin, bayonet or other mainstream lamp base, and used as a general purpose replacement lamp.

The above-described embodiments including the drawings are examples of the invention and merely provide illustrations of the invention. Other embodiments will be obvious to those skilled in the art. Thus, the scope of the invention is determined by the appended claims and their legal equivalents rather than by the examples given.

### INDUSTRIAL APPLICABILITY

The invention has application to the building and lighting industries.

What is claimed is:

1. A method of making a light-emitting-diode-lamp circuit comprising the steps of:
providing a circuit board for a light emitting diode lamp, the circuit board comprising a top surface and a bottom surface, each comprising a surface of the circuit board;
dispersing a plurality of light emitting diodes across a surface of the circuit board;
distributing a light-emitting-diode driver on the a surface of the circuit board, the light-emitting-diode driver configured:
so that the light-emitting-diode driver is not a distinctly identifiable component;
does not interfere with the light output of the light emitting diodes; and,
to enable the light-emitting-diode driver to uniformly heat the light emitting diodes when powering the light emitting diodes;
configuring the light-emitting-diode driver to attach to a power input to supply power to the light emitting diodes; and,
integrating a heat sink to a surface of the circuit board, the heat sink configured to uniformly remove heat from the light emitting diodes and the light-emitting-diode driver when the light emitting diodes are powered by the light-emitting-diode driver.

2. A light-emitting-diode-lamp circuit made according to the method of claim 1.
